(19) United States
(12) Patent Application Publication
(10) Pub. No.: US 2015/0033292 A1
(43) Pub. Date: Jan. 29, 2015

(54) Method and System for Sharing and Distributing Content

(71) Applicant: DDN IP Holdings Limited, Nicosia (CY)

(72) Inventors: Thong Nguyen, London (GB); Alexey Blinov, London (GB); Emma Bathgate, London (GB); Oleg Fomenko, Richmond (GB)

(73) Assignee: DDN IP Holdings Limited, Cicosia (CY)

(21) Appl. No.: 13/951,213

(22) Filed: Jul. 25, 2013

(51) Int. Cl. H04L 29/06

(52) U.S. Cl. CPC H04L 63/08; H04L 67/42
USPC 726/4; 709/219

(57) ABSTRACT

A system for distributing content to at least one client device is disclosed. A content host has a processor and a content store, a client device has a processor and a content cache and a permissions store has a computer storage device configured to store permissions data corresponding to a recipient of content. The content host processor is configured to receive a content identifier corresponding to a recipient request for permission to cache an item of content. The content host processor will then parse the permissions data to determine if the recipient has available permissions to cache the requested content. If the user has available permissions, the content host processor modifies the permissions data to include permission to cache the content. The recipient may additionally request for permission to cache a given item of content to be removed in order to increase an amount of permissions available to the recipient.

### FIELD

The present invention relates to a computerised method and system for distributing content to users and furthermore to a method and system for enabling users to share such content.

### BACKGROUND

The consumption of digital content for subscription based streaming and portable download services is commonly focussed around a binary model wherein the consumer may either have a ‘free’ account, as an unsubscribed user, which provides a limited degree of access permissions to the content or alternatively pay for unlimited permissions, as a subscribed user, where the subscriber is then provided with an on-demand subscription service. The term digital content includes digital media content, which in turn includes, but is not limited to, audio content, video and still image content, games content, books content and other digital printed publications.

Streaming will be taken to refer to any means for transmitting an item of content from the servers of a content host via the Internet or a mobile network wherein the transmission is substantially contemporaneous with the rendering of the item of content on a device such as a mobile phone or a personal computer. The item of content could additionally be transmitted in a manner such that no reproduction of the content is possible on the device after the cessation of the transmission.

Conversely, a portable download refers to a use- and time-limited item of content that it delivered to a subscriber's device from the content host wherein the subscriber may reproduce the content in both an offline and an online environment. An offline environment is defined as an environment wherein the device does not have access to the content host over the Internet or other mobile network.

‘Free’ accounts for the consumption of such content are characteristically described as non “on-demand” since unsubscribed users usage is subject to various limitations including, but not limited to, the period of time within which one can access the content and/or by a limited degree of control over the content that they consume, for example by the enforced provision of advertisements.

In contrast, subscribers of on-demand services are typically offered unlimited, advertisement-free, on-demand access to streams and portable downloads via their mobile phone and/or personal computer in return for a periodic subscription fee.

As such, consumers who are reluctant to pay for access to the on-demand subscription service but who want to have a greater degree of access and control over the content that they consume may resort to obtaining this content through other means, for example by gaining access to pirated content.

Content distribution services can offer the ability to share content between users. Mobile based content distribution services can make sharing more “personal” and one-to-one. Sharing content in the context of a content distribution service does not mean sending the actual content to the receiving user but simply sharing an identification of the content to be shared, for example the service-specific unique identification of the content to be shared.

It is desirable to provide a system and method that engages consumers who would not otherwise pay for such services whilst still maintaining the security of the provision of content. Furthermore, it is desirable to provide a system and method that allows consumers to share content between their respective devices at the touch of a button.

### SUMMARY

A first aspect of the invention provides a computerised method for distributing content to at least one client device, the method comprising storing in a physical computer storage medium permissions data corresponding to a recipient of content, wherein the permissions data comprises a recipient permissions level and an amount of permissions that are already assigned to the recipient. The computerised method also comprises receiving, from the client device, at a content host a content identifier, wherein the content identifier corresponds to a recipient request for an item of content to be cached on the client device and parsing by a processor the permissions data to determine if the recipient making the request has available permissions to cache the content based on the recipient permissions level and the amount of permissions that are already assigned to the recipient.

Furthermore, if the processor determines that the recipient has available permissions to cache the content then the method comprises the processor modifying the permissions data to include permission to cache the content and transferring the item of content to the client device.

This computerised method allows a recipient to cache a set number of items of content on a client device, with the number of items of content being dependent on the permissions level assigned to the recipient and provides a method for authenticating and administrating this. The permission to cache the content may also give the user permission to stream the content to the client device or another device. For example, if the user has permission to cache the content on a mobile device, they may also be permitted to stream the same content to another device such as a personal computer or the like.

In one preferred embodiment, the recipient of the content distributed according to the method is the client device. In an alternative embodiment, the recipient of the content distributed according to the method is a user of the client device.

Preferably, the transferring of the item of content to the client device further comprises sending authentication information, from the content host, to the client device by the processor for authenticating a client device content transfer request. This enables the client device to send an authenticated request for the transfer of the item of content to begin, thus adding to the security of the method embodied.

Preferably the sending of authentication information will comprise sending a short life software token. This short life software token provides the client device with the required authentication for downloading the content within the lifetime of the software token. Once the software token has expired it will no longer be able to be used to authenticate transfer of the item of content. Furthermore, the transfer of the item of content to the client device may be initiated by receiving a request from the client device at the content host containing an identification of the content to be transferred and the authentication information.

The transferring of the item of content to the client device may be initiated by receiving by the processor a request, from the client device, at the content host containing an identification of the content to be transferred and the authentication information.

The parsing step may comprise determining by the processor if including permission to cache the item of content to be cached on the client device would exceed the number of permissions available to the recipient. In this manner, recipients who do not have available permissions for caching additional content are prevented from doing so. If caching the item of content to be cached on the client device would exceed the number of permissions available to the recipient then an error message may be sent from the content host to the client device.

Preferably, versions of the permissions data stored at the client device and content host and these versions may be synchronised periodically. This allows the client device to determine which items of content is has permission to have cached when the device is in an offline environment and not able to contact the content host. However, the permissions data is still stored at the content host and this is considered to be the most secure and authoritative version of the permissions data.

A computer may be caused to carry out the method according to a first aspect of the invention. A non-transient, tangible medium or media having the necessary instructions for distributing content to at least one client device which, when executed by a computer, cause the computer to perform the steps of: storing in a physical computer storage medium permissions data corresponding to a recipient of content, wherein the permissions data comprises a recipient permissions level and an amount of permissions that are already assigned to the recipient, receiving from the client device at a content host a content identifier, wherein the content identifier corresponds to a recipient request for an item of content to be cached on the client device, parsing by a processor the permissions data to determine if the recipient making the request has available permissions to cache the content based on the recipient permissions level and the amount of permissions that are already assigned to the recipient and if the processor determines that the recipient has available permissions to cache the content, the processor modifying the permissions data to include permission to cache the content and transferring the item of content to the client device.

A system for distributing content to at least one client device may also be provided wherein the system comprises a content host having a content host processor and a content storage medium, a client device having a client processor and a content cache and a permissions storage medium configured to store permissions data corresponding to a recipient of content, wherein the permissions data comprises a permissions level and an amount of permissions that are already assigned to the recipient. The content storage medium is configured to store one or more items of content at a content host, the content cache is configured to store one or more number of items of cached content at the client device and the content host processor is configured to parse the permissions data to determine a number of permissions available based on the permissions level and the amount of permissions that are already assigned to the recipient. The content host processor is also configured to receive, from the client processor, a content identifier wherein the content identifier corresponds to a recipient request for an item of content to be cached in the content cache and is configured to modify the permissions data to include permission to cache the content to the permissions data if the recipient has available permissions and to facilitate the transfer of the item of content from the content storage medium to the content cache.

This provides a system for authenticating and administering the process of caching content on a client device wherein a permissions level is assigned to a user that identifies a set number of items of content that may be cached on a client device associated with that user.

The content host processor of such a system may be arranged to send authentication information to the client device for authenticating a client device content transfer request. This enables the client device to send an authenticated request for the transfer of the item of content to begin, thus adding to the security of the method embodied. Furthermore, the authentication information may be a short life software token, which provides the client device with the required authentication for downloading the content within the lifetime of the software token. Once the software token has expired it will no longer be able to be used to authenticate transfer of the item of content.

The system may further comprise a client processor, wherein the client processor and content host processor are arranged to synchronise a version of the permissions data stored at the client device and a version of the permissions data stored at the content host. This allows the client device to determine which items of content is has permission to have cached when the device is in an offline environment and not able to contact the content host whilst still ensuring that the respective versions are up to date.

Furthermore, the client processor may be configured to receive a content identifier wherein the content identifier corresponds to a recipient request for an item of content to be removed from the content cache. The client processor may then be configured to remove the identified item of content from the content cache in response to the recipient request and to notify the content host that the content has been removed. Then the content host processor may be configured to remove the permission to cache the identified item of content from the recipient's permissions data in response to the recipient request.

This allows the amount of permissions available to the recipient to be increased by ‘returning’ an item of content in order to free up storage memory and/or be able to ‘borrow’ another item of content.

A computerised method for managing distributed content that has been distributed to at least one client device may also be provided wherein the method comprises storing in a physical computer storage medium permissions data corresponding to a recipient of content, wherein the permissions data comprises a permissions level and an amount of permissions that are already assigned to the recipient. The computerised method further comprises storing in a content cache associated with the client device one or more items of content that have been distributed by a content host and receiving from the recipient at a client processor an identification of an item of content cached in the content cache that is to be removed from the content cache. The method further comprises removing, by the client processor, the identified item of cached content from the content cache and notifying a content host processor that the indentified item of content has been removed and removing, by the content host processor, from the permissions data the permission corresponding to the removed item of content, whereby the amount of permissions already assigned to the recipient is reduced.

In one preferred embodiment, the recipient of the content distributed according to the method is the client device. In an alternative embodiment, the recipient of the content distributed according to the method is a user of the client device.

A corresponding computer program may also be provided. A non-transient, tangible medium or media having the necessary instructions for distributing content to at least one client device which, when executed by a computer, cause the computer to perform the steps of: storing in a physical computer storage medium permissions data corresponding to a recipient of content, wherein the permissions data comprises a permissions level and an amount of permissions that are already assigned to the recipient, storing in a content cache associated with a client device one or more items of content that have been distributed by a content host, receiving from the recipient at a client processor an identification of an item of content cached in the content cache that is to be removed from the content cache, removing by the client processor the identified item of cached content from the content cache and notifying a content host processor that the indentified item of content has been removed and removing by the content host processor from the permissions data the permission corresponding to the removed item of content, whereby the amount of permissions already assigned to the recipient is reduced.

According to a second aspect of the invention, a computerised method may be provided for personalising a user's content consumption experience. The method comprises receiving by a content host processor from a client device an identification of an online profile corresponding to a user of the client device, wherein the online profile comprises content preference information.

The content preference information from the online profile is then parsed to identify one or more content creators. Next the content host processor determines a personalised selection of previously compiled content playlists based upon the one or more content creators identified then the content host processor causes the personalised selection to be presented to the user. This method enables the previously compiled content playlists to be adapted to a given user based on third party information regarding the user. Furthermore, the personalisation may be configured to occur within the time it takes for the user to register for the content distribution service such that the previously compiled content playlists are personalised the first time they are presented to the user.

This method advantageously enables higher quality and more relevant recommendations to be presented to the user, which may in turn increase the amount of content that the user requests permission to cache.

Optionally, the method may further comprise receiving by the content host processor authentication information from the client device, wherein the authentication information enables the content host processor to parse the content preference information from a private online profile. This allows the content host to gain access to the third party information regarding the user's content preferences even if this information is not publically accessible.

A computer may be caused to carry out a method according to a second aspect of the invention. A non-transient, tangible medium or media having instructions for personalising a user's content consumption experience which, when executed by a computer, cause the computer to perform the steps of: receiving by a content host processor, from a client device, an identification of an online profile corresponding to a user of the client device, wherein the online profile comprises content preference information, parsing by the content host processor the content preference information from the online profile to identify one or more content creators, determining by the content host processor a personalised selection of previously compiled content playlists based upon the one or more content creators identified and causing by the content host processor the personalised selection to be presented to the user.

According to the second aspect of the invention, a system may also be provided for personalising a user's content consumption experience. The system may comprise a content host processor for receiving, from a client device, an identification of an online profile corresponding to a user of the client device, wherein the online profile comprises content preference information, wherein the content host processor is configured to parse the online profile content preference information to identify one or more content creators. The content host processor may be further configured to determine a personalised selection of previously compiled content playlists based upon the one or more content creators identified and to cause the personalised selection to be presented to the user.

According to a third aspect of the invention, a computerised method for sharing content between a sharing entity and a receiving entity is provided, wherein the method comprises capturing, by a sharing entity sensor, an image presented by the receiving entity wherein the image visually encodes an identification of the receiving entity and sending, by a sharing entity processor, to the identified receiving entity an identification of an item of content to be shared wherein the identification of an item of content to be shared is sent via a server.

Advantageously, this method enables the sharing entity to send an identification of an item of content to a receiving entity over the internet without the need for the sharing or receiving entities to physically enter the identifications of the respective devices. This in turn reduces the risk of a typographical error causing the sharing of content to fail.

Preferably the identification of the receiving entity is visually encoded by a Quick Response code. This provides a standardised means for passing the information from one entity to another entity that utilises a camera or similar device.

Optionally, the method may further comprise sending via a server, by the sharing entity processor, an identification of the sharing entity to the identified receiving entity. This allows the receiving entity to identify the sharing entity that has shared the item of content.

According to the third aspect of the invention, a non-transient, tangible medium or media having instructions for sharing content between a sharing entity and a receiving entity which, when executed by a computer, cause the computer to perform the steps of: capturing, by a sharing entity sensor, an image presented by the receiving entity wherein the image visually encodes an identification of the receiving entity and sending, by a sharing entity processor, to the identified receiving entity an identification of an item of content to be shared, wherein the identification of an item of content to be shared is sent via a server.

Furthermore, a system may be provided for sharing content between a sharing entity and a receiving entity, the system comprising a sharing entity sensor for sensing an image presented by the receiving entity wherein the image visually encodes an identification of the receiving entity. This system further comprises a sharing entity processor for sending, via a server, to the identified receiving entity, an identification of an item of content to be shared.

Similarly, a computerised method for sharing content between a sharing entity and a receiving entity may be provided, wherein the method comprises receiving, by a server processor, from a sharing entity processor an identification of the receiving entity and an identification of an item of content to be shared. The identification of the receiving entity may be received at the sharing entity processor by the sensing of an image displayed by the receiving entity that visually encodes the identification of the receiving entity. The method further comprises sending, to the receiving entity, from the server processor the identification of the content to be shared.

Optionally, the method may further comprise receiving at the server processor, from the sharing entity an identification of the sharing entity and sending, by the server processor, to the receiving entity the identification of the sharing entity. This allows the receiving entity to identify the sharing entity that has shared the item of content.

Alternatively, a computerised method for sharing content between a sharing entity and a receiving entity may be provided, wherein the method comprises capturing, by a receiving entity sensor, an image presented by the sharing entity wherein the image visually encodes an identification of the sharing entity and an identification of the content to be shared and sending, by a receiving entity processor, to the identified sharing entity, via a server, an identification of the content to be shared and an identification of the receiving entity.

This method advantageously enables the receiving entity to pull the identification of the content to be shared to itself without requiring the identifications of the content or of the sharing entity to be manually input, which might lead to typographical errors that would disrupt the sharing process. Furthermore, the method advantageously provides the sharing entity with the identification of the receiving entity that it shared content with.

Preferably the identification of the sharing entity and the identification of the content to be shared is visually encoded by a Quick Response code. This provides a standardised means for passing the information from one entity to another entity that utilises a camera or similar device.

Furthermore a non-transient, tangible medium or media may be provided having instructions for sharing content between a sharing entity and a receiving entity which, when executed by a computer, cause the computer to perform the steps of: capturing, by a receiving entity sensor, an image presented by the sharing entity wherein the image visually encodes an identification of the sharing entity and the content to be shared and sending, by a receiving entity processor, to the identified sharing entity, via a server, an identification of the content to be shared and an identification of the receiving entity.

Furthermore, a system may be provided for sharing content between a sharing entity and a receiving entity, the system comprising a receiving entity sensor for sensing an image presented by the sharing entity wherein the image visually encodes an identification of the sharing entity and an identification of the content to be shared and a receiving entity processor for sending, via a server, an identification of the receiving entity and the identification of the content to be shared to the identified sharing entity.

Similarly, a computerised method for sharing content between a sharing entity and a receiving entity may be provided, wherein the method comprises receiving, by a server processor, from a receiving entity processor an identification of an item of content to be shared. The identification of the item of content to be shared may be received at the receiving entity processor by the sensing of an image displayed by the sharing entity that visually encodes the identification of the item of content to be shared. The method further comprises sending, to the sharing entity, from the server processor the identification of the content to be shared and the identification of the receiving entity.

A computerised method for sharing content between a sharing entity and a receiving entity may be provided, wherein the method comprises: causing by a sharing entity processor a datagram packet to be broadcast to one or more receiving entities within the same subnetwork, the user datagram protocol packet requesting the identifications of the one or more receiving entities, receiving at the sharing entity processor one or more datagram packets identifying the respective receiving entities and sending by a sharing entity processor an identification of an item of content to be shared to one or more of the one or more receiving entities.

Furthermore a non-transient, tangible medium or media may be provided having instructions for sharing content between a sharing entity and a receiving entity which, when executed by a computer, cause the computer to perform the steps of: causing by a sharing entity processor a datagram packet to be broadcast to one or more receiving entities within the same subnetwork, the user datagram protocol packet requesting the identifications of the one or more receiving entities, receiving at the sharing entity processor one or more datagram packets identifying the respective receiving entities and sending by a sharing entity processor an identification of an item of content to be shared to one or more of the one or more receiving entities.

These methods advantageously enable users of sharing entities to discover users of receiving entities that are connected to the same local subnetwork by using broadcast packets. These users can be assumed to be in close proximity to each other and therefore likely to wish to share content with each other.

A computerised method for sharing content between a sharing entity and a receiving entity may be provided, wherein the method comprises: sending by a sharing entity processor to a server an identification of a wireless computer network that the sharing entity is connected to, receiving at the sharing entity processor from the server an identification of one or more receiving entities associated with the same wireless computer network as the sharing entity in response to a request from the sharing entity processor and sending by a sharing entity processor an identification of an item of content to be shared to one or more of the one or more receiving entities in response to a user selection.

Furthermore a non-transient, tangible medium or media may be provided having instructions for sharing content between a sharing entity and a receiving entity which, when executed by a computer, cause the computer to perform the steps: sending by a sharing entity processor to a server an identification of a wireless computer network that the sharing entity is connected to, receiving at the sharing entity processor from the server an identification of one or more receiving entities associated with the same wireless computer network as the sharing entity in response to a request from the sharing entity processor and sending by a sharing entity processor an identification of an item of content to be shared to one or more of the one or more receiving entities in response to a user selection.

These methods advantageously enable users of sharing entities to discover users of receiving entities that are connected to the same wireless computer networks by associating users with an identification of the wireless computer network that they are connected to. These users can be assumed to be in close proximity to each other and therefore likely to wish to share content with each other.

### BRIEF DESCRIPTION OF THE DRAWINGS

Embodiments of the invention will now be described in more detail, by way of example only, and with reference to the following drawings in which:

FIG. 1: is an example of a screen showing pre previously compiled content playlists;

FIG. 2: is an example of a screen showing information regarding the currently playing media;

FIG. 3: is an example of a music discovery screen;

FIG. 4: is an example of a screen showing a collection of units of content;

FIG. 5: is a block diagram embodying the first aspect of the invention;

FIG. 6: is a flowchart embodying a method for managing requests for permission to cache content according to the first aspect of the invention;

FIG. 7: is a flowchart embodying a method for authenticating a transfer of content according to the first aspect of the invention;

FIG. 8: is a flowchart embodying a method for requesting for permission to be withdrawn according to the first aspect of the invention;

FIG. 9: is a block diagram embodying the second aspect of the invention;

FIG. 10: is a flowchart embodying a method for personalising a user's experience based on the user's associated online information according to the second aspect of the invention;

FIG. 11: is a block diagram embodying a first embodiment of the third aspect of the invention;

FIG. 12: is a simplified system diagram of the system of FIG. 11;

FIG. 13: is an example of a QR code according to the first embodiment of the third aspect of the invention;

FIG. 14: is a flowchart embodying a method for sharing content according to the first embodiment of the third aspect of the invention;

FIG. 15: is a block diagram embodying a second embodiment of the third aspect of the invention;

FIG. 16: is a flowchart embodying a method for sharing content according to the second embodiment of the third aspect of the invention;

FIG. 17: is an example block diagram showing a system for obtaining user identifications from a contact list;

FIG. 18: is an example block diagram showing a system for obtaining user identifications of users associated with nearby GPS coordinates;

FIG. 19: is a block diagram embodying a system using a local subnetwork according to the third aspect of the invention;

FIG. 20: is a flowchart embodying a method for sharing content using a common local subnetwork according to the third aspect of the invention;

FIG. 21: is a flowchart embodying a method for sharing content using a common wireless computer network according to the third aspect of the invention;

FIG. 22: is a block diagram embodying a system using a wireless computer network according to the third aspect of the invention.

### DETAILED DESCRIPTION

A first aspect of the invention provides a method and system for facilitating the consumption of digital content by users or recipients having a tiered account structure with increased permission levels being afforded for each subsequent tier. The permission levels are based on a given metric, which may, for example, determine the number of units of content that a recipient is allowed to consume within a given period of time. This unit may be based on a temporal duration, a quantity of digital information, an item of content, a collection of items of content or indeed all items of content from a given content creator. The term digital content includes digital media content, which in turn includes, but is not limited to, audio content, video and still image content, games content, books content and other digital printed publications.

The recipient of the content may be a user or a client device that is associated with one or more users. The terms recipient and user will be taken to be interchangeable in the foregoing description.

From the above, it will be apparent that the unit of content, for example music or video content, may be a set number of minutes, megabytes, tracks/episodes, albums/seasons or artists/series. Alternatively, the metric may determine a given number of units of content that a user is permitted to cache. Cached content is a duplicate of content that is stored on a client semi-permanently, wherein a client is any device that is capable of accessing the content host for example over a computer network such as the Internet. Accordingly, in some embodiments the client may be a smartphone, a tablet, a laptop or a desktop computer.

The permission to cache content may also give the recipient permission to stream the same content to a given device. This means that a user may choose to stream content to devices for which the ability to cache is limited, for example by a limited amount of free storage memory.

The method may be implemented in a software application that runs on the client. This client application may be preinstalled on a client or may be downloaded to the client subsequently. When the client application has been loaded, the user may be presented with a screen. This screen may additionally provide the ability to navigate to a number of other screens within the client application. In one screen, a series of previously compiled pre-programmed playlists of content may be presented to the user. These pre-programmed playlists are collections of units of content from various content creators that have been compiled around a given theme. When the playlist is selected, a shuffled subset of the units of content from the playlist will begin playing, wherein the shuffled subset complies with any licensing restrictions that have been imposed by the content creators or licensors.

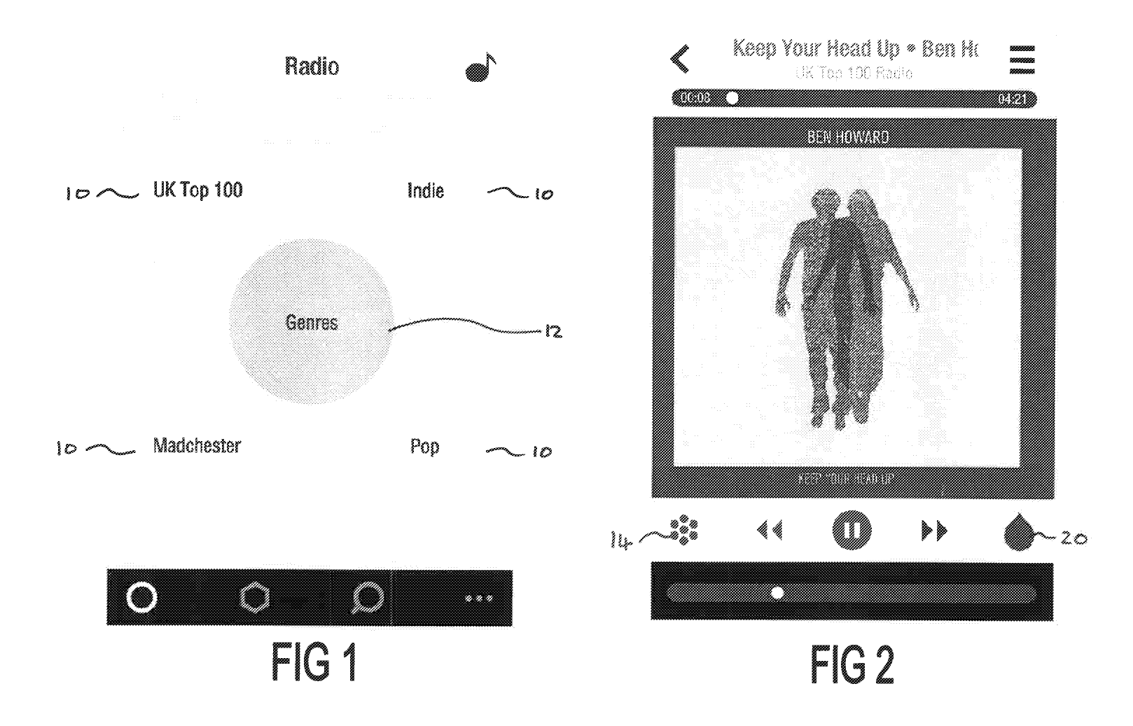

An example of a screen showing a number of previously compiled content playlists 10 can be seen in FIG. 1. In this example, the previously compiled playlists 10 are known as “radio stations” and comprise a collection of songs by various music creators. The radio stations presented may be a default set of playlists, the playlists that are currently most popular or alternatively may be personalised to a given user as will be described later on. The example screen of FIG. 1 also comprises an icon 12 that, when selected, takes the user to a full list of the available radio stations.

Whilst playing any item of content, the user may be presented with information about that item of content as depicted in FIG. 2. In a variation of an embodiment of the invention, each screen providing information about an item of content is additionally provided with an icon 14 that, when selected, takes the user to a screen that displays a selection of content creators 16 that create similar content to the creator 18 of the previously presented item of content.

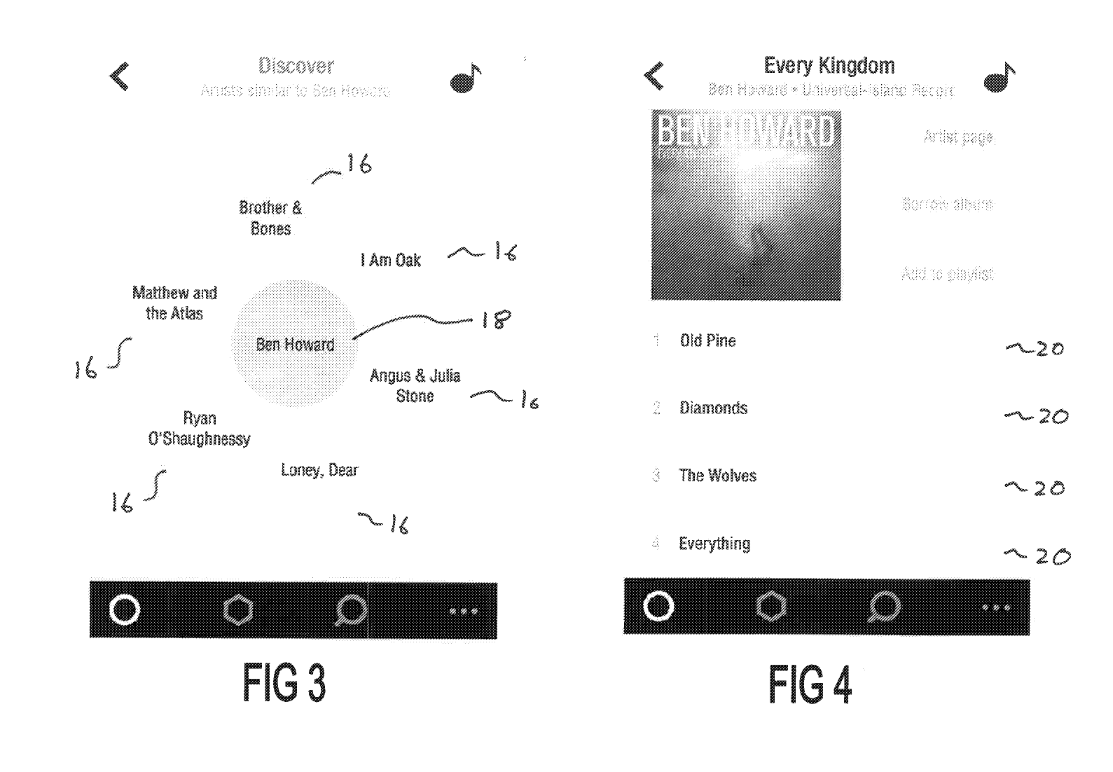

An example of such a screen can be seen in FIG. 3. If the user selects one of the similar content creators 16 then they will become the content creator 18 and a further selection of content creators 16 that create content to the newly selected content creator 18 will be displayed. In this manner, users can discover new content that they may like. If the user selects the content creator then they will be directed to a screen that displays all of the available content collections from that content creator, for example all of the available albums by a given musical artist or all of the available books by a given author.

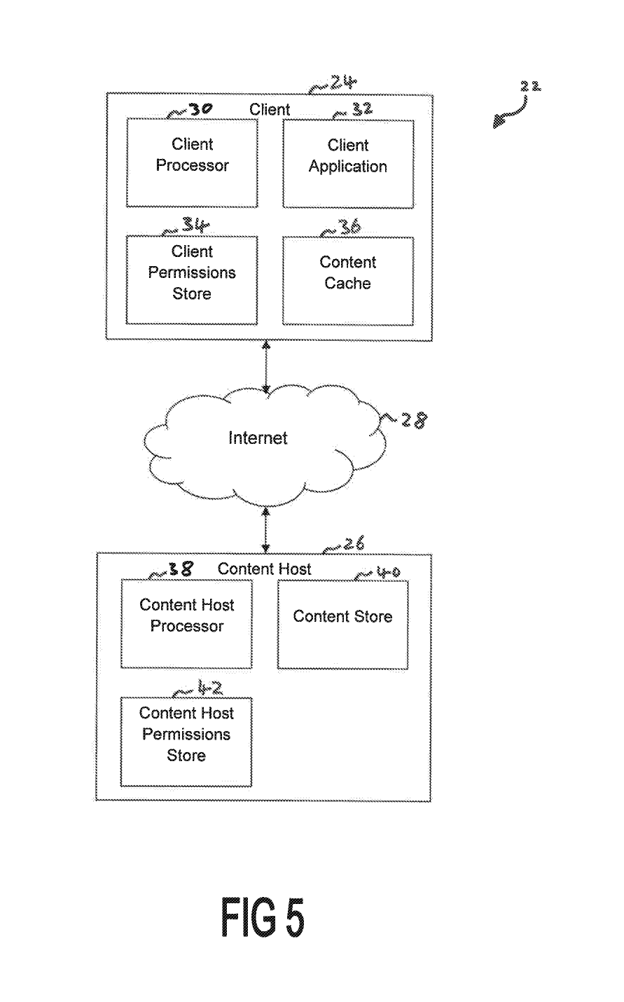

FIG. 4 shows a screen comprising a collection of items of content in an example of an embodiment of the invention. In an embodiment of the invention, an icon 20 is displayed in connection with every item of content that appears in any screen of the client application. By selecting the icon 20, the user may request to cache the associated unit(s) of content onto their client device. Alternatively this could be requested by the execution of a gesture action that is associated with the caching of the presently selected content.

In a variation of an embodiment of the invention, the metric defines a given number of units of content that a user is permitted to cache on an associated client. This permission to cache may be used to cache the content on the client or alternatively to stream the content to a client. However, this provides additional challenges with regards to the secure management of content and enforcement of the various levels of permissions that each respective consumer may have. Previously there has been no motivation to solve such a problem since, in the prior art, users are either not permitted to cache any content or are able to cache and/or stream any and all content, albeit potentially with a given temporal expiry.

FIG. 5 is a block diagram illustrating an embodiment of the first aspect of the present invention. This embodiment provides a system 22 for enabling a client 24 to cache content held at a content host 26 over a computer network 28, such as the Internet. The client 24 comprises a client processor 30, a client application 32, a client permissions storage medium 34 and a content cache 36. The content host comprises a content host processor, a content storage medium 40 and a content host permissions storage medium 42. The content host permissions storage medium 42 contains a plurality of entries that set out the permissions that are associated with an identification of each user and/or recipient of content. The client permissions storage medium 34 contains entries that set out the permissions that are associated with the identification of the user that is associated with the client 24. The client processor 30 and the content host processor 38 are arranged to periodically synchronise the respective sets of permissions data held in the client permissions storage medium 34 and content host permissions storage medium 42 for the user associated with the client 24.

The content host 26 stores the content in the one or more content storage media 40. Furthermore, permissions data exists that associates each user with a given level of permissions and sets an expiry period for the permissions data. This permissions data may be stored by the content host in the content host permissions storage medium 42, or alternatively on the client device itself in the client permissions storage medium 34. The permissions data may include a table that details the units of content that a given user currently has permission to cache on, or stream to, an associated client device.

In a further variation, the permissions data is stored both at the content host 26 and at the client device 24 with the respective sets of data being synchronised periodically, for example, each time the user requests to modify the permissions by requesting permission to cache further content or by surrendering the permission to cache a given unit of content. By storing the permissions data with the client 24, it is possible for the client 24 to determine if the client 24 has permission to execute a given unit of content when the client 24 is in an offline mode, i.e. does not have access to the content host 26 over the computer network 28. Content may be executed by playing the content through an audio and/or visual content player.

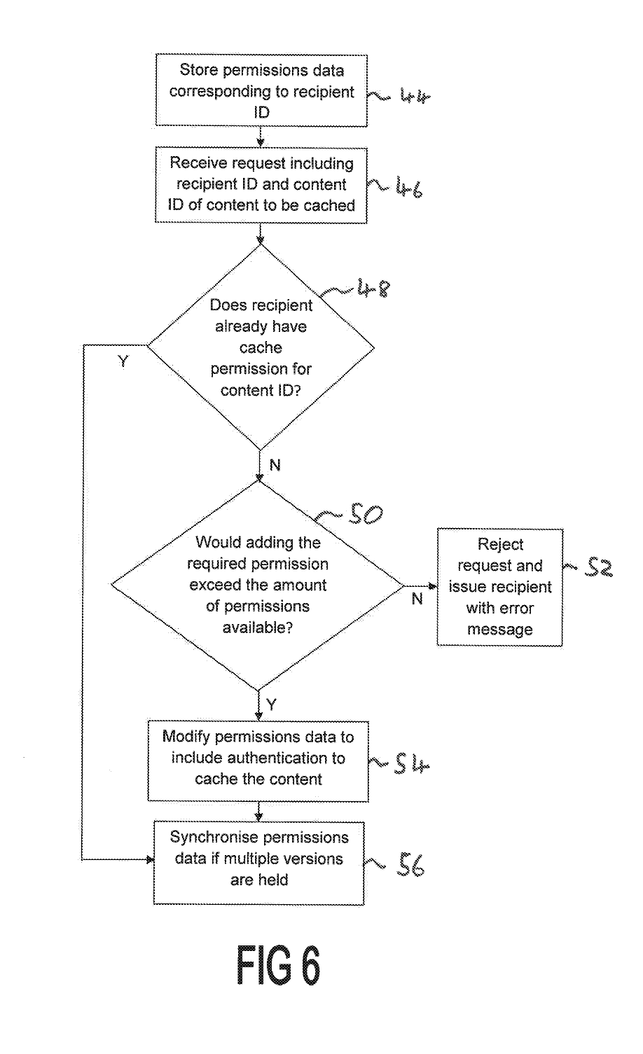

FIG. 6 is a flowchart describing a method for managing requests for permission to cache content. Permissions data is stored in a permissions storage medium (34; 42) and includes permissions data for each individual user as shown in step 44 of FIG. 5. When a user requests for the content to be cached at step 46, a processor (30; 38) will interrogate the permissions data in order to determine if the user already has permission to cache the given unit of content as shown in step 48. If the user does not already have permission then the method will progress to step 50 where the processor (30; 38) will determine if the user has available permissions to cache the requested additional units of content. For example, the processor (30; 38) may calculate whether or not granting permission to cache the presently selected content would exceed the number of units of content that the user has permission to cache (and therefore permission to stream) at any one point in time.

In the event that the user does not have permission to cache additional content, then they may be presented with an error message as shown in step 52. This error message may additionally contain information regarding how to expand the user's permission level such that they would be permitted to cache the content.

If it is determined that the user has available permissions to cache the requested content then the method will move onto step 54 where the processor (30; 38) will cause an entry to be added to the permissions data (34; 42) to indicate the permission for the user to cache the requested unit of content. If multiple versions of the permissions data are stored, for example at both the content host 26 and client device 24, then these will be synchronised at step 56.

At this point, the recipient and/or user will now have permission to stream and/or cache the requested content to an associated client device 24. The actual streaming and/or caching of content may follow on as a direct consequence from the requesting of permission to cache the content shown in FIG. 6 or alternatively may be initiated in a separate step. This transfer of data to the client device 24 may be initiated by the content host 26.

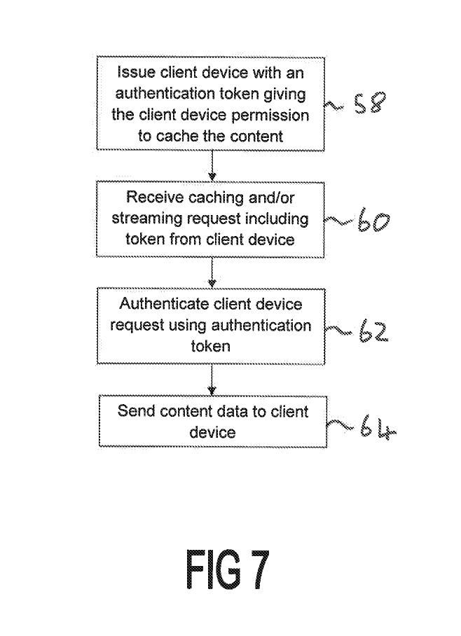

In a variation of the embodiment, the client device 24 may initiate the transfer of data from the content host 26, in which case the data transfer request will need to be authenticated. In step 58 of FIG. 7 the client and/or content host processor (30; 38) causes the client device 24 to be issued with authentication for the transfer of the requested unit of content from the content host storage 40 to the client device storage for streaming and/or caching. This authentication may be issued using a short life software token that is sent from the content host 26 to the client 24 over a computer network 28, such as the Internet, and received at the client device.

The client device 24 may then send an authenticated request for the transfer of the requested content which will be received at the content host 26 at step 60. This authenticated request may be in the form of a resource identifier, such as a uniform resource locator, that includes the token in the resource identifier string sent. The request will then be authenticated by the content host processor 38 at step 62 and the requested content will be transferred to the client device 24 at step 64. If this token does not form part of the resource request then the transfer will be denied by the content host processor 38.

The token may only be valid for a short period of time to ensure that the token cannot be redistributed, which might otherwise allow third parties to successfully request to cache or stream the content using the same token. Optionally, the token may also be tied to an identification number associated with the requesting client device 24 and/or user such that no other users and/or client devices may successfully request for the transmission of content using a token that was issued to another user.

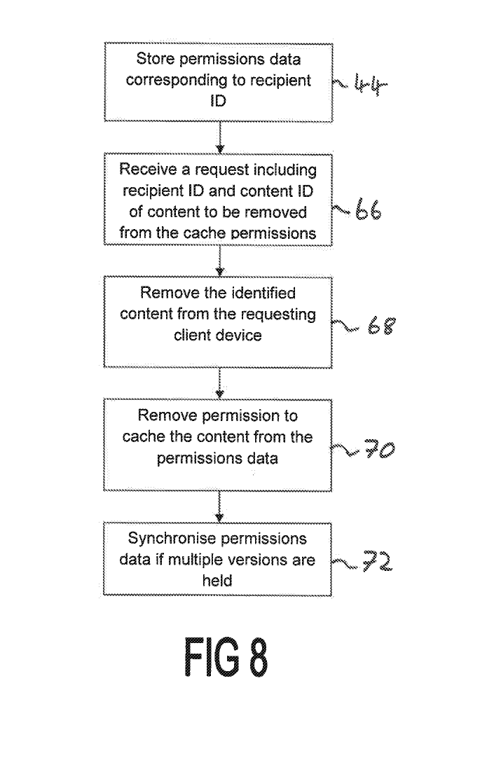

If the user wishes to delete an item of content from their cache 36, for example to free up storage space or permissions to cache other units of content, then they may request for the respective permissions to be withdrawn. A method for requesting for permissions to be withdrawn is shown in FIG. 8 with the request being received at the content host 26 at step 66. The client processor 30 will cause the corresponding content to be removed from the requesting client device 24 at step 68, this step may be carried out substantially simultaneously with step 66 and in some embodiments step 68 may precede step 66. The content host processor 38 will then remove permission to cache the corresponding content from the user's permissions data at step 70.

In a preferred embodiment, the permissions are withdrawn by causing the processor to add a flag to the respective entry in the permissions data to indicate that the permission is no longer valid. By maintaining this data, rather than simply deleting the permissions entry, a history of a given user's previous cache states may be compiled and may in turn be used for analytics purposes in order to improve the services provided by the content host 26. If multiple versions of the permissions data are stored, for example at both the content host 26 and client device 24, then these will be synchronised at step 72.

In the embodiment wherein the permissions data is stored both at the client 24 and with the content host 26, the respective copies of the permissions data must be regularly synchronised to ensure that each version is up to date. When the client 24 alters its permissions data, the client processor 30 will send the new permissions to the content host 26 at the first opportunity. For example, if the client 24 is in an offline environment when the permissions change then the client 24 will need to wait until it transitions into an online environment before sending the new permissions to the content host 26.

Along with the new permissions data, the client 24 also sends the current version of the permissions it has stored. The content host processor 38 will then compare the received permissions data with the version of the permissions data held at the content host 26 and calculate the differences between the two versions. The content host processor 38 will then apply these alterations to the permissions data stored by the content host 26 such that the respective sets of permissions data match. The content host 26 will then increase the version number and send the new set of permissions and the new version number to the client 24. The client will then store the new set of permissions and the new version number.

The content host 26 performs all of the calculations necessary to determine the new set of permissions based on the permissions and the version number the client 24 has sent. These calculations may be trivial or, in case of multiple client hosts making changes to the permissions at the same time, may be rather involved. The client processor 30 may also cause the permissions data to be synchronised each time that the client application 32 is loaded or opened on the client device 24.

In a variation of the first embodiment of the invention, users can also request for content to be streamed to their client devices 24 for execution in a manner similar to the caching of content described above. However, streamed content is only temporarily stored on the client 24 and as such a new token must be requested each time the user requests for a unit of content to be streamed and played. In a preferred embodiment, the content host processor 38 will issue users that do not have unlimited permissions with a streaming token that only authenticates a preview of the requested content to be streamed to the client device 24. Preferably the preview is a 30 second sample of the content in question.

If the user wishes to play the full version of the selected content then they may, if they have the required permissions available, request for permission to cache the selected content. The user may then stream the full version of the selected content or alternatively request of the content to be cached to the user's device 24. Caching allows the user to execute the content in full both when the device is in an online or an offline state. If the user does not have the necessary permissions available for caching the additional content then they may be given the option to and/or choose to upgrade their permissions level. Alternatively the user may first surrender the permission to cache one or more units of content as described above, deleting the associated cached content if it has been cached on the client. This increases the user's available permissions such that they can cache the additional content.

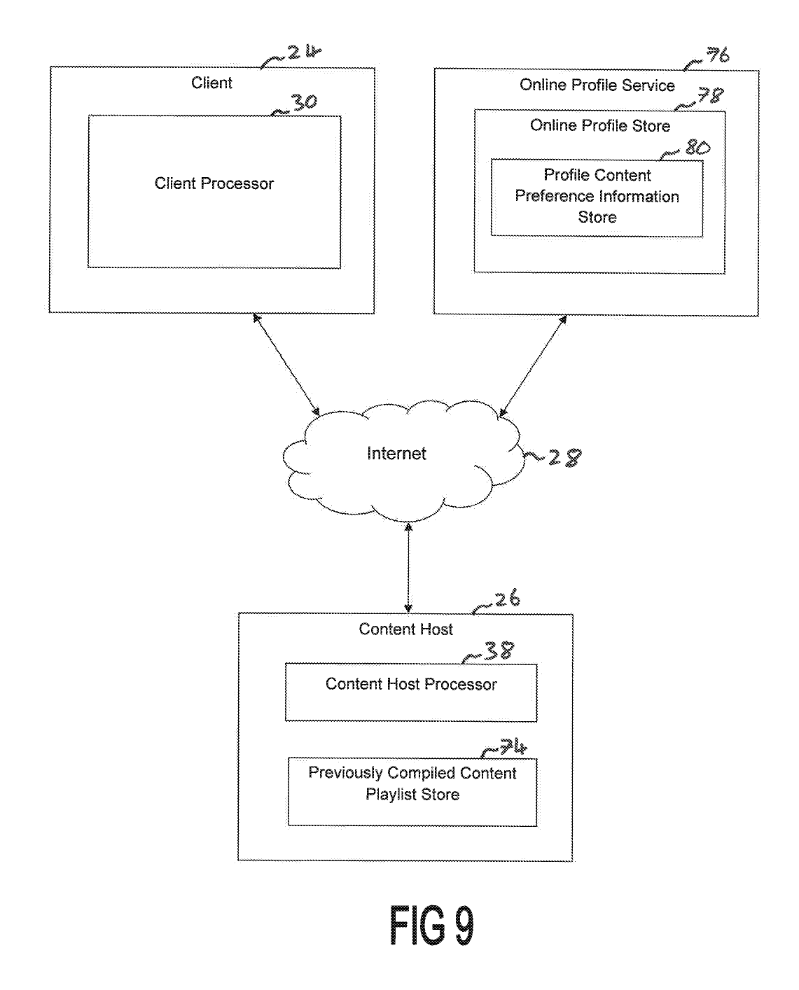

In a second aspect of the invention, a system and method for personalising a user's experience based on the user's current online presence is provided. FIG. 9 is a block diagram embodying this second aspect of the invention. A client 24 with a client processor 30 and a content host 26 with a content host processor 38 are provided and arranged to be communicate over a computer network 28, such as the Internet, as in the first aspect of the invention. In this aspect of the invention, the content host 26 is additionally provided with a previously compiled content playlist storage medium 74 to store the previously compiled content playlists 10 described above. An online profile service 76 is provided with an online profile storage medium 78 that stores profile information regarding one or more users of the online profile service including content preference information, which is stored in the profile content preference information storage medium 80.

The online profile service is also arranged to be able to communicate with the content host 26 over a computer network 28, such as the Internet. In one embodiment, when the user loads the client application 32, the user will be presented a screen showing a number of previously compiled content playlists 10 as described above for FIG. 1. The previously compiled playlists may be personalised to the user's content preferences by associating the user with an online profile comprising content preference information that is held at an online profile service.

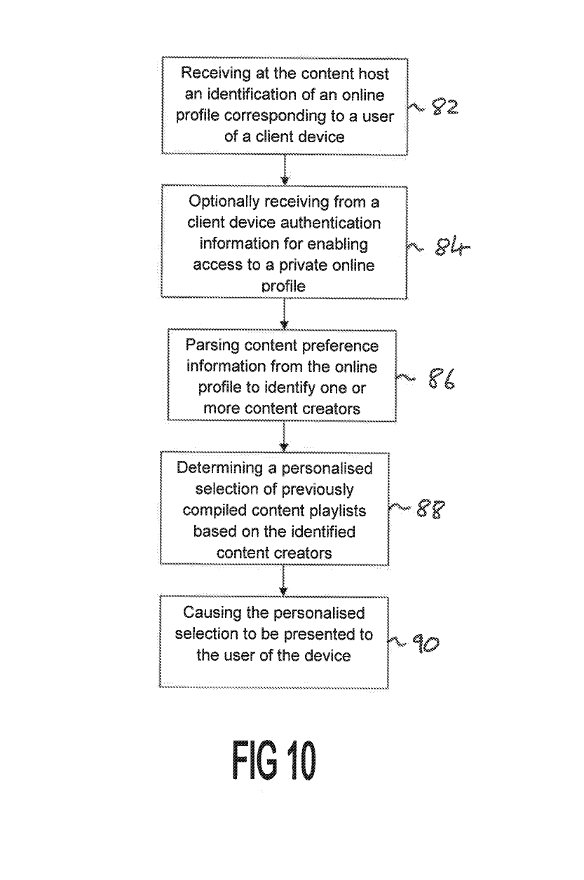

When a user registers for an account for consuming digital content, they may optionally provide an identification of an online profile that represents them. For example, this could be an account they hold with a social networking site such as Facebook. FIG. 10 describes a method according to this aspect of the invention with the identification of an online profile corresponding to the user being received at step 82.

If data regarding the user's content preferences is available publically then the content host processor 38 could be arranged to extract this information from the identified online profile contained in the online profile storage medium 78. Alternatively, if this information is not publically accessible then the content host and/or client processor (38; 30) may optionally request for the user to provide authentication information, at step 84, allowing such preference data to be extracted. The authentication information may then be used by the content host processor 78 in a request to the online profile service 76, such as through an application programming interface call.

Once the user's content preferences have been obtained, the content host processor 38 may parse the preference data at step 86 to determine if any units or creators of content are identified. If identifications of content are determined, then the content host processor 38 may use the identifications to determine at step 88 a personalised the set of playlists 10 that may be presented to the user at step 90 as in FIG. 1. The content host processor 38 may carry out these method steps such that the screen containing previously compiled playlists 10 is personalised before it is first presented to the user. As described above, by selecting one of these previously compiled playlists 10, the user will be presented with a shuffled subset of the units of content within the selected playlist 10.

The previously complied playlists 10 that are displayed to a given user may also be personalised based on the user's listening habits as determined by the user's listening history. Similarly, if the user indicates that they believe that a given item of content does not fit into a certain previously compiled playlist 10 then this may also be taken into account when determining the subset of available previously compiled playlists 10 to be displayed to the user.

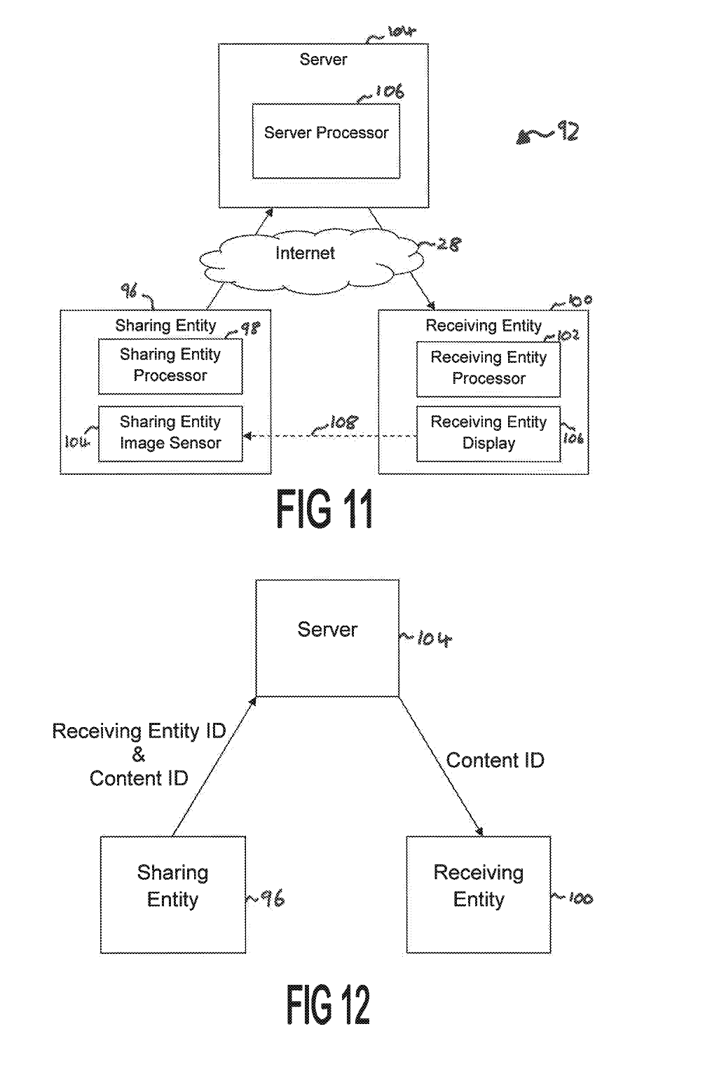

According to a third aspect of the invention, a system and method for sharing content between a sharing entity and a receiving entity is provided. FIG. 11 shows a block diagram for a system 92 according to a first variation of the third aspect of the invention. System 92 is provided with a sharing entity 96 having a sharing entity processor 98, a receiving entity 100 having a receiving entity processor 102 and a server 104 having a server processor 106.

In traditional methods, the entity receiving the shared content 100 would need to search for the content, for example by entering associated metadata as search terms in order to find the content. Alternatively, the sharing entity 96 could enter an identification of the receiving entity 100, for example a username or email address, in order to send the shared content to the receiving entity 100. In both of these methods, errors may arise in the data input and thus may lead to the content not being shared successfully. It is desirable to provide a method that avoids such errors. Bluetooth is a low-power radio technology that could be used for sharing such identifications, but the handshaking and pairing protocols required for Bluetooth operation would require too much user-intervention for this to be a viable alternative.

In a first embodiment of the method of the third aspect of the invention, the sharing entity 96 will send an identification of the recipient entity and an identification of the content to be shared to the server 104. The server 104 may be a central server that is in communication with both the sharing 96 and receiving 100 entities over a computer network 28, such as the Internet. The server 104 is responsible for notifying the receiving entity 100 that they have received a new item of shared content. This notification may be sent, for example, using a push notification or a text message. Alternatively the receiving entity may contact the server 104 periodically in order to determine if any new items of content have been shared with the receiving entity. The skilled person will appreciate that there are many other standard techniques for communicating notifications between a server 104 and a receiving entity 100 and that these methods fall within the scope of this application.

The communications between the sharing entity 96 and the server 104 may be sent using standard Internet protocols such as performing a HyperText Transfer Protocol REpresentational State Transfer (HTTP REST) request. One advantage of using a HTTP REST request for such communication is that HTTP REST requests are able to traverse most firewalls.

In order to be able to share content, the sharing entity needs both an identification of the content and an identification of the receiving entity. This can be seen from FIG. 12, which shows a simplified system diagram corresponding to system 92 of FIG. 11 but with the flow of information indicated in the figure. It should be noted that the sharing entity image sensor 104 and the receiving entity display 106 are optional with reference to FIG. 12 and will only be taken to form a part of FIG. 12 where explicitly stated. The sharing entity 96 will send an identification of the content to be shared to the server 104 along with an identification of the receiving entity 100, with which the sharing entity wishes to share the content. The server 104 will then forward the identification of the content to be shared to the receiving entity, for example by a push notification or by the receiving entity 100 periodically checking in with the server 104 as described above.

Usually the sharing entity or user will want to share an item of content that is currently displayed on the sharing entity device or is currently being executed on the device. As such, the receiving entity will already be aware of the identification of the item of content. However, obtaining the appropriate identification of the receiving entity is significantly more problematic.

Traditionally the sharing entity user would search for a receiving entity user by identifications such as a username, email address (preferably hashed for security) or other user specific metadata. However, the sharing entity user would be required to manually type these identifications corresponding to the user, which is a slow process and particularly so on mobile devices. This slow and involved process would discourage the sharing of content. Users will usually want to share content with a user that they know or who is located in close proximity to them, for example being in the same room or the same building.

In a method of the third aspect of the invention, the identification of the receiving entity may be passed from the receiving entity 100 to the sharing entity 96 using visually encoded information, such as a Quick Response (QR) code image. In such an embodiment, the sharing entity 96 will additionally comprise a sharing entity image/optical sensor 104, such as a camera, for reading or sensing a QR code displayed by the receiving entity 100 on a receiving entity display 106. The dotted line 108 on FIG. 11 shows the transfer of information from the receiving entity 100 to the sharing entity 96 by the sensing of the image displayed by the receiving entity display 106 using the sharing entity image sensor 104.

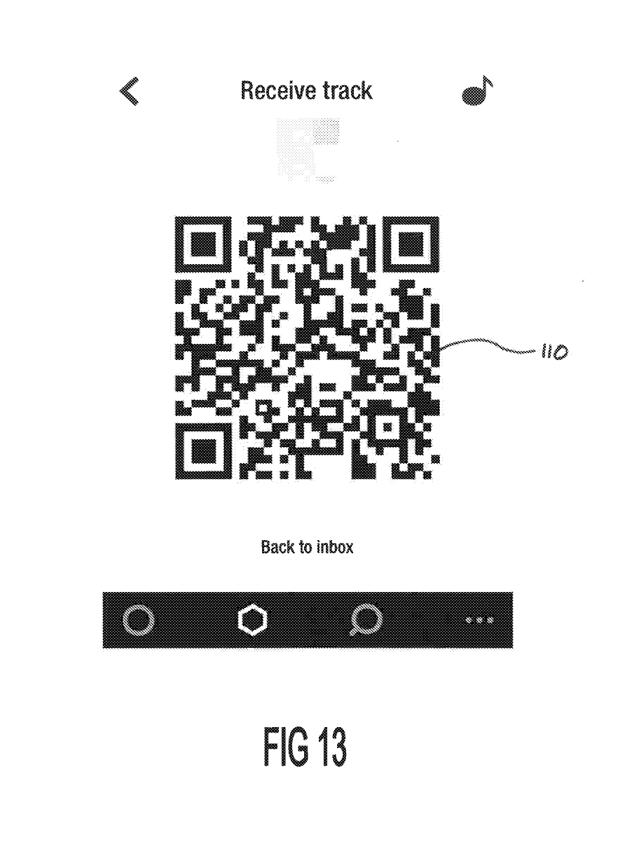

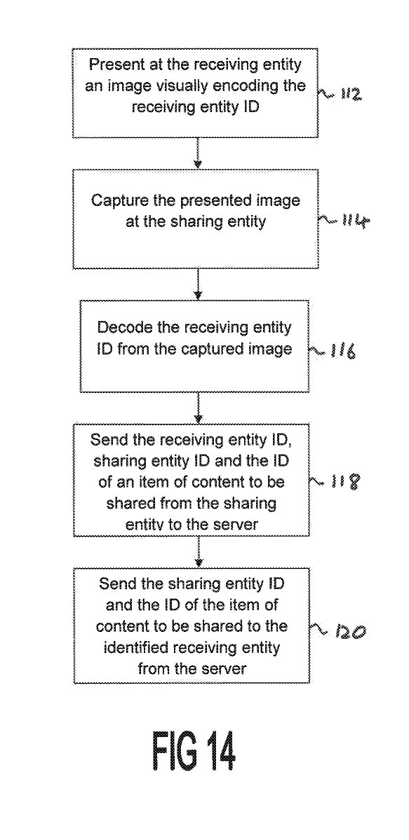

FIG. 13 shows an example of a screen within the client application 32 for displaying a QR code 110 on a receiving entity display 106 to be read or sensed by a sharing entity image sensor 104. FIG. 14 shows a method for sharing content according to this first variation of the invention wherein a QR code is displayed on the receiving entity display 106 at step 112.

The displayed QR code encodes information identifying the receiving entity 100, for example a user/device identification number/name. The QR code may be dynamically generated based on the user that is currently logged in on the receiving entity device. Additional metadata regarding the receiving entity user may also be encoded in order to enable the sharing entity to attribute additional context to the identification of the receiving entity. The sharing entity processor 98 then senses the encoded identifying information at step 114 and decodes the information at step 116. The identifying information is then forwarded to the server 104 along with an identification of the content that is to be shared with the receiving entity 100 and information identifying itself (i.e. the sharing entity 96) at step 118. The sharing entity processor 98 may forward the identifying information to the server 104 in an encoded or decoded state; however, it is preferable that the information is forwarded in the decoded state.

The server 104 then stores an entry that associates the identifications of the sharing 96 and receiving 100 entities and the shared content with each other. In a preferred embodiment, the server processor 106 causes this association of information to be sent to the receiving entity 100 at step 120, for example by sending a push notification. In this embodiment it is the receiving entity processor 102 that generates the encoded information and the shared content is pushed to the receiving entity 100.

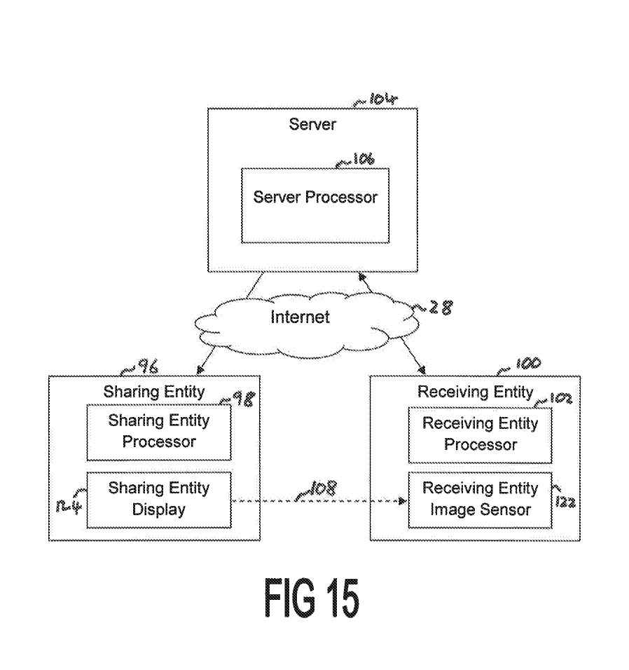

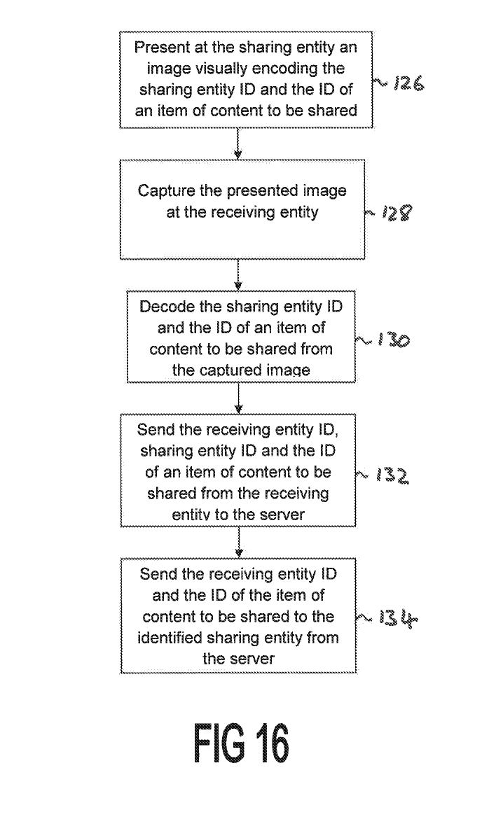

In a second embodiment of the method of the third aspect of the invention, it is the receiving entity 100 that additionally comprises a receiving entity image/optical sensor 122, such as a camera, for reading a QR code displayed instead by the sharing entity 96 on a sharing entity display 124 as shown in FIG. 15 and at step 126 of FIG. 16. The displayed QR code encodes information identifying the sharing entity 96, for example a user/device identification number/name, as well as an identification of the content to be shared. The dynamically generated QR code may be overlaid onto the client application 32 or alternatively displayed in a lock screen of the sharing entity device. For example, the QR code could be overlaid onto the album artwork of a music player in the example of sharing music content.

The receiving entity image sensor 108 then senses the QR code (see dotted line 108 on FIG. 15) at step 128 and then the receiving entity processor 102 then decodes the identifying information at step 130 and forwards it to the server 104 along with an identification of itself (i.e. the receiving entity 100) at step 132. The receiving entity processor 102 may forward the identifying information to the server 104 in an encoded or decoded state; however, it is preferable that the information is forwarded in the decoded state.

The server 104 then stores an entry that associates the identifications of the sharing 96 and receiving 100 entities and the shared content with each other. In a preferred embodiment, the server processor 106 causes this association of information to be sent to the receiving entity 100 at step 134, for example by sending a push notification. However, in a variation of the second embodiment, this entry associating the identifications could be stored at the receiving entity 100 before the receiving entity processor 102 causes the identifications to be forwarded to the server 104. Thus, in this variation it is not necessary for the server processor 106 to cause the association entry to be sent back to the receiving entity 100. In this second embodiment, it is the sharing entity processor 98 that generates the encoded information and the receiving entity processor then causes the shared content identification to be pulled to the receiving entity 100.

Variations of the third aspect of the invention may provide any other optical sensor for reading the visually encoded information and, furthermore, the respective processors may encode the information by any other means that would be known to the skilled person. For example, the processor may cause the information to be encoded using any type of linear barcode, any type of two-dimensional matrix code or indeed by some combination of characters representing the information to be passed between the sharing 96 and receiving 100 entities.

Similarly, the server 104 and server processor 106 may form a part of the content host 26 and the content host processor 38 respectively.

It will be appreciated that Radio-Frequency IDentification (RFID) tags and corresponding RFID readers could be used in accordance with the third aspect of the invention to replace or complement the use of the displays (106, 124) and image sensors (104, 122) described above.

Content may also be shared with a recipient selected from a list of users that the sharing user is likely to want to share content with. According to this embodiment of the third aspect of the invention, this list may be automatically generated based on a number of key factors. When a user is selected from the automatically generated list, the method will proceed as in FIG. 11. One factor could be to include in the automatically generated list a number of the users that that sharing user has recently shared content with and/or users that have recently shared content with the sharing user.

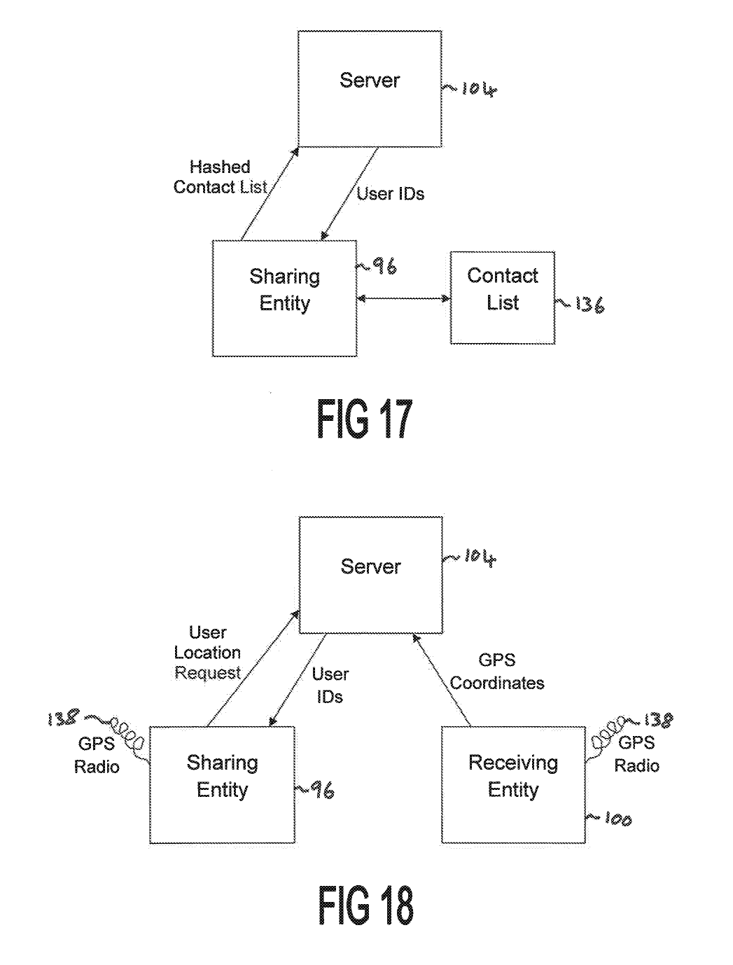

The automatically generated list may also contain users extracted from a generic contact list held on the sharing user's device, for example a list of contact email addresses. As shown in FIG. 17, this list 136 of could be transmitted from the sharing user device/sharing entity 96 to the server 104 (preferably hashed for privacy and security). The server 104 could then attempt to match the received email addresses with service specific identifications of users (User IDs) of the content distribution service. Finally a list of all the matched User IDs could be transmitted back to the sharing entity for incorporation into the automatically generated list of likely share contacts.

Any hashing algorithm may be used. For example MD5 or SHA, which generate hashes by first normalising the information (removing whitespace, converting all characters to lower-case).

A further method may use Global Positioning System (GPS) coordinates to identify users of the content distribution service that are in close proximity to the sharing user that could form part of the automatically generated list of likely share contacts.

With reference to FIG. 18, the respective devices (96, 100) will each comprise a GPS radio unit 138 in order to periodically report their location to the server 104 or may alternatively report their location to the server 104 only when the device is set to a “receive” mode. The sharing entity 96 can then request and retrieve from the server 104 a list of User IDs identifying receiving entities 100 that are currently located near a specific location, preferably the location of the sharing entity 96. The storing of GPS coordinates and querying of a database for geographically located entries close to a given set of GPS coordinates is known and the skilled person will appreciate how to implement this for this invention.

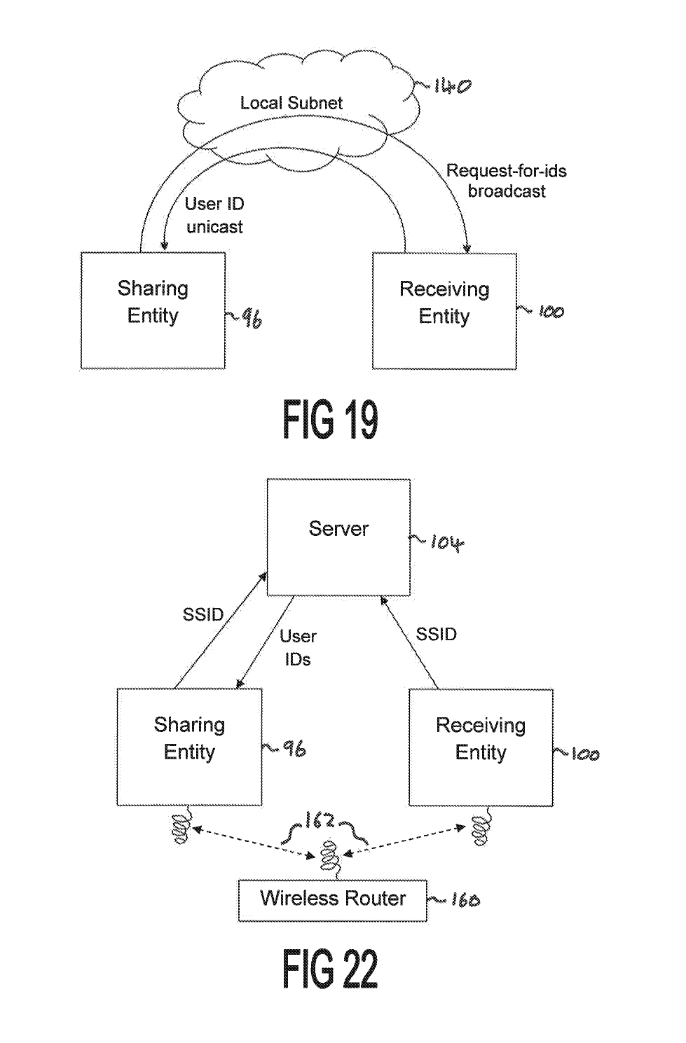

A further method may use a User Datagram Protocol (UDP) broadcast to discover users who are on the same network as the sharing entity 96, and thus can be assumed to be in close proximity to the sharing entity 96. FIG. 19 shows a block diagram of a sharing entity 96 and a receiving entity 100 that are both connected to a local subnetwork 140, such as a local area network.

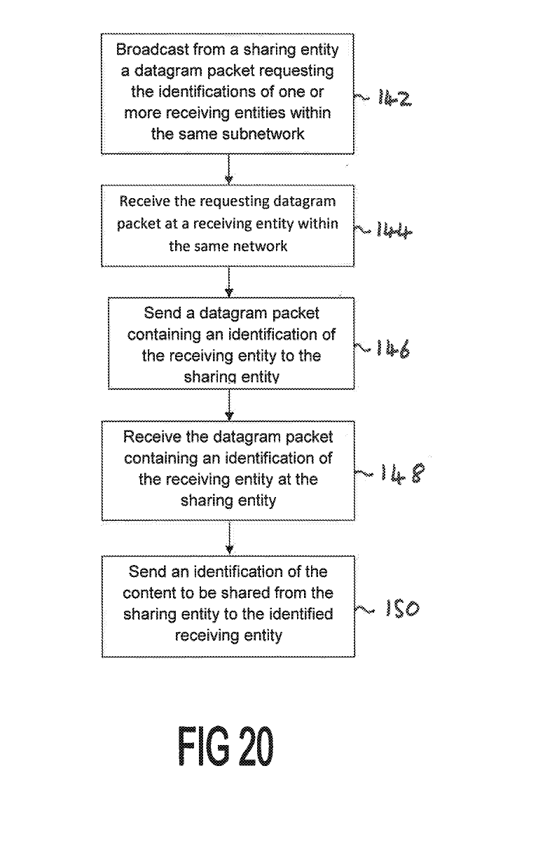

FIG. 20 is a flowchart of the method according to this aspect of the invention. At step 142 the sharing entity processor 98 will send a request-for-ids UDP broadcast packet to the local subnetwork and then any devices 100 that are also running the content distribution client application 32 will listen to the request-for-ids UDP packet at step 144 and respond by sending a direct (unicast) identifier UDP packet containing the receiving entity's User ID back to the sharing entity 96 at step 146, which is received at step 148.

The method may then proceed as shown in FIG. 12 with the sharing entity processor 98 sending an identification of the content to be shared to the server 104 along with an identification of the receiving entity 100, with which the sharing entity wishes to share the content. The server processor 106 will then forward the identification of the content to be shared to the receiving entity, for example by a push notification or by the receiving entity processor 102 periodically checking in with the server 104 as described above. It will be appreciated that the server 104 may be replaced in this embodiment with the subnetwork 140, such that the identification of the content to be shared is sent directly from the sharing entity processor 98 to the receiving entity 100 over the subnetwork 140 at step 150, for example by a unicast transmission.

In order to ensure that the automatically generated list always includes nearby user devices regardless of the order in which the sending and receiving devices become active it is necessary to also to have all devices (sharing or receiving) broadcast (i.e. not unicast) their identifier UDP packet whenever the client application 32 is launched or resumes from the background and/or to have all devices (sharing or receiving) broadcast a request-for-ids UDP packet periodically when they are in a sharing/receiving mode.

However, some wireless computer networks, in particular WiFi networks, prevent UDP broadcast packets from being routed. These sorts of restrictions are common on public wireless computer networks and corporate networks. This restriction can be overcome by understanding that every wireless computer network has a public unique identifier known as the Service Set IDentification (SSID).

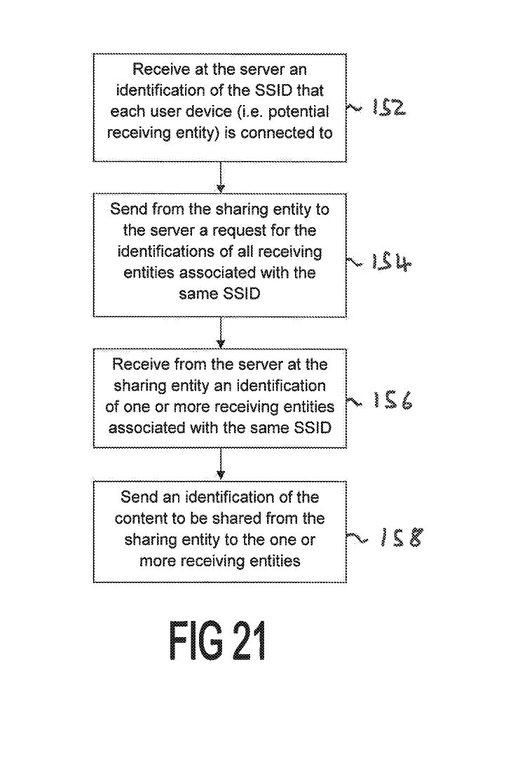

Accordingly, we propose a further method of discovering nearby receiving entities by utilising the SSID of the wireless computer network. This method is set out in the flowchart of FIG. 21. In the method, every user will send to the content distribution service's server 104 the SSID of the wireless computer network that they are currently connected to at step 152. These SSIDs are then stored against the User ID associated with each respective device/receiving entity 100.

A sharing entity processor 98 may then query the server 104 for a list of all of the identifications of receiving entities 100 that are associated with a wireless computer network having the same SSID at step 154. Then at step 156 the server processor 106 will send the identifications of all receiving entities 100 that are associated with the same SSID to the sharing entity 96. Finally the sharing entity processor 98 may send an identification of the content to be shared to one or more of the identified receiving entities 100 that are connected to the common wireless computer network. This part of the method may be carried out as shown in FIG. 12 and the corresponding description above. However, it will be appreciated that the server 104 may be replaced in this embodiment with the wireless computer network, such that the identification of the content to be shared is sent directly from the sharing entity processor 98 to the receiving entity 100 over the wireless computer network at step 158.

FIG. 22 is a block diagram of a system according to this aspect of the invention. The sharing entity 96 and receiving entity 100 are both connected to the same wireless computer network by one or more wireless routers 160 as shown by dotted lines 162. Both the sharing 96 and receiving 100 entities will know the SSID of the wireless computer network they are connected to and will send this to the server 104 periodically, for example whenever the client application 32 loads or each time the entity connects to a different wireless computer network. This communication may be sent via the wireless computer network or by any other means available to the sharing/receiving entity.

This method uses the SSID of a wireless computer network in conjunction with a database on a central server 104 in order to enable user devices that are connected to the same wireless computer network (and thus can be assumed to be in close proximity) to discover each other. The method can be modified to protect the privacy of wireless computer networks by requiring the SSIDs of wireless computer networks to be hashed before they are sent to the central server 104.

It will be appreciated by the skilled person that the above methods may also be initiated by the receiving entity and that these methods also fall within the scope of this application.

What is claimed is:

1. A computerised method for distributing content to at least one client device, the method comprising:
storing in a physical computer storage medium permissions data corresponding to a recipient of content, wherein the permissions data comprises a recipient permissions level and an amount of permissions that are already assigned to the recipient;
receiving, from the client device, at a content host a content identifier, wherein the content identifier corresponds to a recipient request for an item of content to be cached on the client device;
parsing by a processor the permissions data to determine if the recipient making the request has available permissions to cache the content based on the recipient permissions level and the amount of permissions that are already assigned to the recipient; and
if the processor determines that the recipient has available permissions to cache the content, the processor modifying the permissions data to include permission to cache the content and transferring the item of content to the client device.

2. The computerised method of claim 1, wherein the recipient of the content is the client device.

3. The computerised method of claim 1, wherein the recipient of audio and/or visual content is a user of the client device.

4. The computerised method of claim 1, wherein the transferring of the item of content to the client device further comprises sending authentication information, from the content host, to the client device by the processor for authenticating a client device content transfer request.

5. The computerised method of claim 4, wherein the sending of authentication information comprises sending by the processor a short life software token.

6. The computerised method of claim 4, wherein the transferring of the item of content to the client device is initiated by receiving by the processor a request, from the client device, at the content host containing an identification of the content to be transferred and the authentication information.

7. The computerised method of claim 1, wherein the parsing step further comprises determining by the processor if including permission to cache the item of content to be cached on the client device would exceed the number of permissions available to the recipient.

8. The computerised method of claim 1, wherein if the processor determines that the recipient does not have available permissions to cache the content the method further comprises rejecting the recipient request.

9. The computerised method of claim 8, wherein the rejecting of the recipient request further comprises sending by a processor, from the content host, to the client device an error message.

10. The computerised method of claim 1, further comprising synchronising versions of the permissions data stored at the client device and content host.

11. A system for distributing content to at least one client device comprising:
a content host having a content host processor and a content storage medium;
a client device having a client processor and a content cache; and
a permissions storage medium configured to store permissions data corresponding to a recipient of content, wherein the permissions data comprises a permissions level and an amount of permissions that are already assigned to the recipient and wherein:
the content storage medium is configured to store one or more items of content;
the content cache is configured to store one or more items of cached content;
the content host processor is configured to parse the permissions data to determine a number of permissions available based on the permissions level and the amount of permissions that are already assigned to the recipient;
the content host processor is configured to receive, from the client processor, a content identifier wherein the content identifier corresponds to a recipient request for an item of content to be cached in the content cache; and
the content host processor is additionally configured to modify the permissions data to include permission to cache the content to the permissions data if the recipient has available permissions and to facilitate the transfer of the item of content from the content storage medium to the content cache.

12. The system of claim 11, wherein the content host processor is further configured to send authentication information to the client processor for authenticating a content transfer request.

13. The system of claim 12, wherein the authentication information is a short life software token.

14. The system of claim 11, wherein the client processor and the content host processor are configured to synchronise a version of the permissions data stored at the client device and a version of the permissions data stored at the content host.

15. The system of claim 11, wherein:
the client processor is configured to receive a content identifier wherein the content identifier corresponds to a recipient request for an item of content to be removed from the content cache;
the client processor is further configured to remove the identified item of content from the content cache in response to the recipient request and to notify the content host processor that the content has been removed; and
the content host processor is configured to remove the permission to cache the identified item of content from the recipient's permissions data in response to the recipient request.

16. A computerised method for managing distributed content distributed to at least one client device, the method comprising:
storing in a physical computer storage medium permissions data corresponding to a recipient of content, wherein the permissions data comprises a permissions level and an amount of permissions that are already assigned to the recipient;
storing in a content cache associated with the client device one or more items of audio and/or visual content that have been distributed by a content host;
receiving, from the recipient, at a client processor an identification of an item of content cached in the content cache that is to be removed from the content cache;
removing, by the client processor, the identified item of cached content from the content cache and notifying a content host processor that the indentified item of content has been removed; and
removing, by the content host processor, from the permissions data the permission corresponding to the removed item of content, whereby the amount of permissions already assigned to the recipient is reduced.

17. The computerised method of claim 16, wherein the recipient of audio and/or visual content is the client device.

18. The computerised method of claim 16, wherein the recipient of audio and/or visual content is a user of the client device.

19. A system for personalising a user's content consumption experience, the system comprising:
a content host processor for receiving, from a client device, an identification of an online profile corresponding to a user of the client device, wherein the online profile comprises content preference information, wherein:
the content host processor is configured to parse the online profile audio and/or visual content preference information to identify one or more content creators; and
the content host processor is further configured to determine a personalised selection of previously compiled content playlists based upon the one or more content creators identified and to cause the personalised selection to be presented to the user.

20. A system for sharing content between a sharing entity and a receiving entity, the system comprising:
a sharing entity sensor for sensing an image presented by the receiving entity wherein the image visually encodes an identification of the receiving entity; and
a sharing entity processor for sending, via a server, to the identified receiving entity, an identification of an item of content to be shared.

21. A system for sharing content between a sharing entity and a receiving entity, the system comprising:
a receiving entity sensor for sensing an image presented by the sharing entity wherein the image visually encodes an identification of the sharing entity and an identification of the content to be shared; and
a receiving entity processor for sending, via a server, an identification of the receiving entity and the identification of the content to be shared to the identified sharing entity.

22. A computerised method for sharing content between a sharing entity and a receiving entity, the method comprising:
causing, by a sharing entity processor, a datagram packet to be broadcast to one or more receiving entities within the same subnetwork, the user datagram protocol packet requesting the identifications of the one or more receiving entities;
receiving at the sharing entity processor one or more datagram packets identifying the respective receiving entities; and
sending, by a sharing entity processor, an identification of an item of content to be shared to one or more of the one or more receiving entities.

23. A computerised method for sharing content between a sharing entity and a receiving entity, the method comprising:
sending, by a sharing entity processor, to a server an identification of a wireless computer network that the sharing entity is connected to;
receiving, at the sharing entity processor, from the server an identification of one or more receiving entities associated with the same wireless computer network as the sharing entity in response to a request from the sharing entity processor; and
sending, by a sharing entity processor, an identification of an item of content to be shared to one or more of the one or more receiving entities in response to a user selection.
